(19) United States
(12) Patent Application Publication
(10) Pub. No.: US 2018/0118434 A1
(43) Pub. Date: May 3, 2018

(54) Unknown

(71) Applicant: Coveris Rigid (Zell) Deutschland GmbH, Zell/Kaimt (DE)

(72) Inventor: Dieter BERGNER, Niedernhall (DE)

(73) Assignee: Coveris Rigid (Zell) Deutschland GmbH, Zell/Kaimt (DE)

(21) Appl. No.: 15/800,281

(22) Filed: Nov. 1, 2017

(30) Foreign Application Priority Data
Nov. 2, 2016 (DE) 10 2016 120 920.1

(51) Int. Cl. B65D 65/42; B65D 1/34; B65D 1/40; B65D 25/34; B65D 43/02; B29C 51/16

(52) U.S. Cl. CPC B65D 65/42; B65D 1/34; B65D 1/40; B29L 2031/712; B65D 43/02; B29C 51/162; B65D 25/34

(57) ABSTRACT

Tub-shaped or dish-shaped packaging with a lower part (1) and/or a cover (31) of a thermomouldable and/or injection mouldable material, preferably a plastics material, wherein at least one surface is formed to be modified with respect to its appearance and/or its feel.

The invention relates to tub-shaped or dish-shaped packaging with a lower part and/or an upper part of a thermomouldable and/or injection-mouldable material, preferably a plastics material.

The most diverse forms of packaging of this kind, including not only tubs and dishes, but also covers, are known, but these have a smooth surface which does not impart a high-quality impression particularly with respect to touch.

Consequently, a bandarole or the like of paper, paperboard or cardboard is often used to ensure a high-quality and pleasing appearance.

This, however, is very expensive.

It is consequently the object to produce an equivalent appearance in advantageous mode and manner which, in addition, is to remain insensitive to environmental influences.

According to the invention this object is fulfilled in that at least one surface is formed to be modified with respect to the appearance thereof and/or feel thereof.

As a result, a pleasing surface which imparts a high-quality impression is created.

In that case it has proved very advantageous if the surface is provided partially or over the whole area with one or more structures.

A pleasing feel is achieved by the structuring. In that case, either a fine structuring which improves tactile characteristics or a coarse structuring which produces, for example, forms of appearance very close to corrugated cardboard or the like is conceivable. A combination of fine and coarse structures is conceivable. Equally conceivable are several fine and/or several coarse structures or mixed forms thereof.

According to the invention it is also very advantageous if an IML, i.e. an in-mould label, is provided, which is placed in a deep-drawing mould or an injection-moulding mould and then the packaging is produced, in which case the IML is furnished with the intended surface and thus the desired surface with structuring is produced.

The desired, paper-like and high-quality feel is thereby produced in simple mode and manner.

Moreover, according to the invention it has proved very advantageous if the surface is provided with a coating.

It is very advantageous if the coating is carried out by a printing method.

Such a coating makes the respective surface softer. The coating can be carried out by, for example, a printing method, as a result of which structuring can already be created.

In that case, according to a further embodiment of the invention it is very advantageous if the coating is applied by a structured coating roller and thus the surface structuring formed.

The coating of the surface with a coating and a surface structuring are thereby produced in one step.

It is in that case also extremely advantageous if the coating comprises a matt lacquer.

A matt lacquer material equally produces a pleasing tactile sensation and can create the impression of a paper or paperboard surface.

A further very advantageous development of the invention is present if the deep-drawing mould is furnished with one or more surface structures and the structuring in the tub and/or the cover thereby formed.

This is a very simple, but effective possibility of production. The structuring can in that case be provided in, for example, the walls or the surface.

According to the invention it is extremely advantageous if the structure depth of a structure is between 10 and 60 microns, preferably between 30 and 50 microns.

The best results in terms of tactility were thereby achieved. In the case of use of an IML, a smaller structure depth is usually provided than in the case of direct modification of a surface.

According to the invention it is also extremely advantageous if the structure depth of a structure is between 60 and 2,000 microns, preferably between 100 and 1,000 microns.

The impression of, for example, corrugated cardboard can be created very satisfactorily by such a coarse structuring.

According to a further development of the invention it is also very advantageous if the structuring of each structure is produced within the tool by etching, laser action and/or mechanical processing.

Different structures with different degrees of fineness can thereby be produced. Excellent results were achieved by all these tools produced in such a way.

Similarly, according to the invention it is very advantageous if the packaging is produced from a multi-layer, preferably at least a double-layer, plastics material foil.

Such packaging can, for example, have at the outer side thereof a foil layer adapted in terms of feel, which can also consist of an IML or a coating. Disposed in the interior is the actual carrier layer and on the inner side, for example, a barrier layer.

According to a further embodiment of the invention it is very advantageous if the single or at least the outermost foil layer is filled.

Haptic and tactile changes can thus also be achieved.

In that case it is very advantageous if mineral fillers, preferably lime, are provided as filling material, wherein the proportion of filling material can be between 10 and 30 weight percent, preferably about 20 weight percent.

The best results with respect to characteristics of feel and also with respect to impression were achieved by such a filling. The impression of paper packaging could be created. The result can be further improved by an additional matt coating.

The invention is explained in the following by way of two embodiments.

In that case:

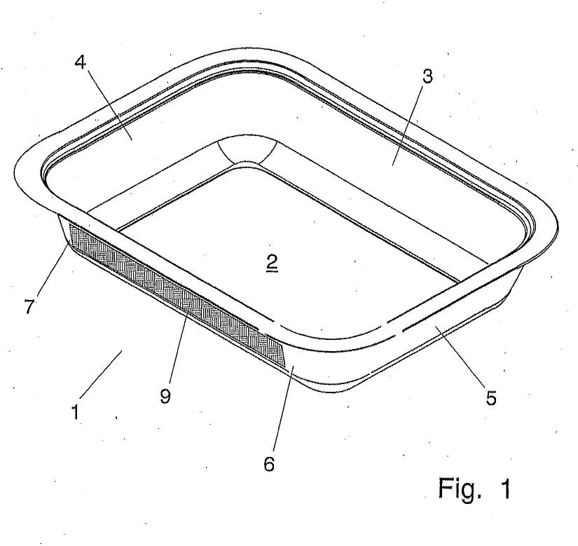

FIG. 1 shows a diagram of a dish according to the invention with a base and four side walls connected therewith,

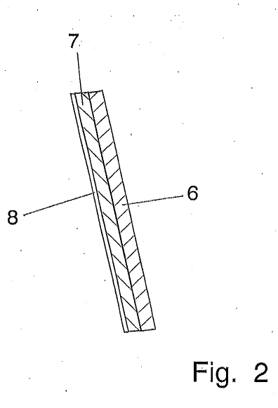

FIG. 2 shows a section through one of the side walls,

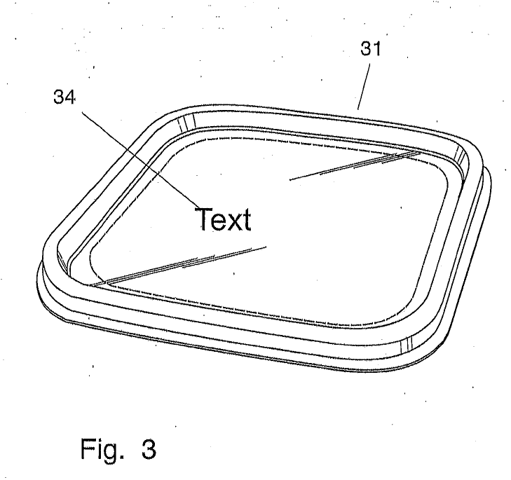

FIG. 3 shows a diagram of a cover according to the invention and

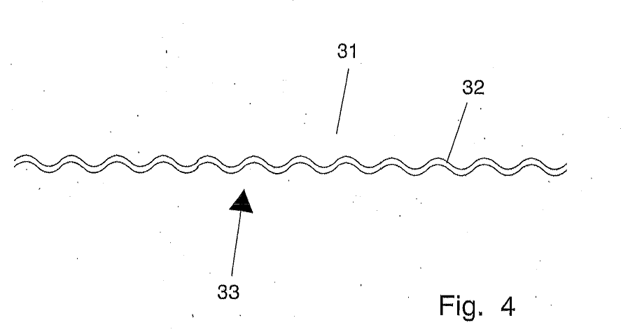

FIG. 4 shows a section through the cover surface.

A dish-shaped container with a base 2 and four side walls 3, 4, 5 and 6 adjoining thereat is denoted by 1 in FIG. 1. In that case, round, oval or rounded shapes are also conceivable.

Dishes 1 of that kind are usually produced in a deep-drawing method or also in an injection-moulding method from thermoplastically deformable material such as, for example, PE, PET, PP, PLA or other plastics.

These dishes have a smooth surface.

At the present time, a high-quality impression is not accorded to plastic materials. In addition, this plastic material impression is problematic particularly with respect to disposal of plastic materials.

An impression invoking the appearance of a paper surface is significantly better here and more readily accepted.

For that purpose, according to the present invention the surface is modified at least in part regions.

In the present embodiment the side walls 3, 4, 5 and 6 are furnished with a special IML 7, which during deep-drawing of the dish 1 is placed in the mould and then a plastics material foil is deep-drawn in this mould.

The IML 7 is coated on its outer side, which faces the deep-drawing mould, with a lacquer 8, here a transparent lacquer 8, which was applied by means of a structured coating roller to the IML 7.

The structuring of the coating roller ideally lies in the range of 30 to 50 microns surface roughness. A surface roughness between 10 and 60 microns is conceivable.

The structuring 9 is in that case rather irregular, wherein repetitions and regularities can also be provided. The structuring of the roller is produced by etching, laser action or mechanical processing.

The surface of the IML receives a paper-like character through the fine structuring and, in particular, not only in a visual respect, but also with respect to feel.

The coating 8 can in that case also be realised directly on an already-produced dish 1 or directly on the plastics material foil to be deep drawn.

The coating 8 can comprise a matt lacquer.

The use of an IML 7 is particularly recommended in the case of use of an injection-moulding method for producing the dish 1.

It is also conceivable for the structuring 9 to be realised only at the time of deep-drawing or injection-moulding of the dish 1 itself, i.e. the injection-moulding or deep-drawing mould is itself appropriately structured at the desired places or regions.

This embodiment of the invention can not only be used in respect of the dishes 1 discussed in this exemplifying embodiment, but also tubs or covers 31 for packagings can be created. In particular, snap lids, for example for dishes 1, which convey the impression of paper at least with respect to feel can be readily produced.

Dispensing with the coating is conceivable.

The foil construction can comprise two or more layers, in which case an inner layer 21 consisting of a barrier, a middle carrier layer 22 and the outer layer 23 with the feel of paper is particularly advantageous.

It is also conceivable if, at least in the coating 23 having the feel of paper, a mineral filler, particularly lime with a proportion of between 10 and 30 weight percent, preferably about 20 weight percent, is provided. The feel of paper is equally produced by this filler in conjunction with the above-described micro-structuring. The use of a matt lacquer 8 for covering the layer 23 is conceivable, in which case the structuring 9 should then be provided in the matt layer 8. In the case of use of a mineral filler, it is also possible to dispense with the structuring.

According to a further embodiment, such as illustrated in FIGS. 3 and 4, additionally or alternatively a second, substantially coarse structuring can be provided.

This embodiment is illustrated by way of a cover 31.

The coarse structure 32 is of wave-shaped arrangement in this embodiment and can approximately correspond with the structure of corrugated cardboard.

The feel of paper is thereby further amplified.

In the present embodiment the structuring in combination with a matt lacquer is particularly efficient. The illustrated cover 31 is correspondingly furnished on its inner side 33, where against a printed image 34 is provided on its outer side.

The combination of coarse structuring, filled surface layer and matt lacquer, in particular, produces good results.

In that case it is conceivable that with a combination of the micro-structuring and the coarse structuring 32, which has a depth in the range 60 to 200 microns, preferably between 100 and 1,000 microns, the difference from paper will be very hard to tell with respect to characteristics of feel.

The coarse structuring can also have other forms, but the wave structure exhibits the best results.

The coarse structuring 32 of the cover 31 is produced by an appropriate deep-drawing or injection-moulding mould.

This embodiment is not restricted just to covers 31, but is also conceivable for tubs and dishes of the most diverse shapes and dimensions.

As a rule, a structured IML is used in injection-moulding and also in thermomoulding, i.e. deep-drawing. It is also possible, particularly in the case of thermomoulding, to dispense with the IML so that the structure is provided in the respective form. For improvement of feel, a preferably more matt lacquer can be applied by a printing method beforehand.

In the case of thermomoulding, the material thickness of a cover usually lies between 200 and 600 microns, preferably at approximately 450 microns.

In thermomoulding, a tub or a dish usually has material thicknesses between 400 and 1,000 microns, preferably between 600 and 800 microns.

1: Tub-shaped or dish-shaped packaging with a lower part and/or a cover of thermomoldable and/or injection-moldable material, preferably a plastics material, wherein at least one surface is formed to be modified with respect to the appearance thereof and/or the feel thereof.

2: Packaging according to claim 1, wherein the surface is provided partially or over the whole area with one or more structures.

3: Packaging according to claim 1, wherein an IML, i.e. an in-mold label, is provided, which is placed in a deep-drawing mold or an injection-molding mold and then the packaging is produced, wherein the IML is furnished with the intended surface and thus the desired surface with structuring is created.

4: Packaging according to claim 1, wherein the surface is provided with a coating.

5: Packaging according to claim 4, wherein the coating is applied by a printing process.

6: Packaging according to claim 4, wherein the coating is undertaken by a structured application roller and thus the surface structure is formed.

7: Packaging according to claim 4, wherein the coating is a matt lacquer.

8: Packaging according to claim 1, wherein the deep-drawing mold is furnished with one or more surface structures and thus the structuring is formed in the tub and/or the cover.

9: Packaging according to claim 1, wherein the structure depth of a structure is between 10 and 60 microns, preferably between 30 and 50 microns.

10: Packaging according to claim 1, wherein the structure depth of a structure is between 60 and 2,000 microns, preferably between 100 and 1,000 microns.

11: Packaging according to claim 1, wherein the structuring of each structure is produced in the tool by etching, laser action and/or mechanical processing.

12: Packaging according to claim 1, wherein the packaging is produced from a multi-layer, preferably at least double-layer, plastics material foil.

13: Packaging according to claim 1, wherein the single or at least the outermost foil layer is filled.

14: Packaging according to claim 13, wherein mineral fillers, preferably lime, are provided as filling material, wherein the proportion of filling material can be between 10 and 30 weight percent, preferably about 20 weight percent.
